(19) United States
(12) Patent Application Publication
(10) Pub. No.: US 2016/0298586 A1
(43) Pub. Date: Oct. 13, 2016

(54) INTERNAL COMBUSTION ENGINE

(71) Applicant: TOYOTA JIDOSHA KABUSHIKI KAISHA, Toyota-shi (JP)

(72) Inventor: Koshiro KIMURA, Susono-shi (JP)

(73) Assignee: TOYOTA JIDOSHA KABUSHIKI KAISHA, Toyota-shi (JP)

(21) Appl. No.: 15/044,903

(22) Filed: Feb. 16, 2016

(30) Foreign Application Priority Data
Apr. 13, 2015 (JP) 2015-081972

(51) Int. Cl. F02M 59/22; F02F 1/24; F02B 23/10

(52) U.S. Cl. CPC F02M 59/22; F02B 23/10; F02F 1/242; F02B 2023/106

(57) ABSTRACT

An internal combustion engine where a tumble flow is generated inside a combustion chamber includes: a spark plug; an in-cylinder injection valve that injects fuel at a specific timing so that a fuel spray proceeds towards the vortex center of the tumble flow at the time of stratified charge combustion operation; a variable tumble flow device for making the strength of a tumble flow variable; and a control device configured, when the spray penetration force of fuel injected by the in-cylinder injection valve is increased due to a change over time of the internal combustion engine, to close the variable tumble flow device during the stratified charge combustion operation.

### BACKGROUND

1. Technical Field

Preferred embodiments relate to an internal combustion engine, and more particularly to an internal combustion engine in which stratified charge combustion operation is performed utilizing a tumble flow.

2. Background Art

A control device for an in-cylinder direct injection engine that performs stratified charge combustion operation is disclosed in Japanese Patent Laid-Open No. 2002-276421. In order to perform stratified charge combustion operation by retaining a combustible air-fuel mixture at the periphery of a spark plug at the spark timing, the aforementioned control device is configured to inject fuel towards a tumble flow that flows towards the fuel injection valve so that the fuel moves in a direction that is counter to the direction of the tumble flow. In addition, to achieve a balance between the strength of the tumble flow and a spray penetration force of the fuel and thereby realize stable stratified charge combustion, the control device adjusts the spray penetration force by controlling the fuel injection pressure. More specifically, at a time of idling operation, while gradually changing the fuel injection pressure within a total range from a set lower limit value to a set upper limit value, processing is performed that corrects the fuel injection timing so that the size of a combustion fluctuation within the aforementioned total range becomes equal to or less than a predetermined value.

### LIST OF RELATED ART

Following is a list of patent documents which the applicant has noticed as related arts of the present application.

### [Patent Document 1]

Japanese Patent Laid-Open No. 2002-276421

### [Patent Document 2]

Japanese Patent Laid-Open No. 2003-227375

### [Patent Document 3]

Japanese Patent Laid-Open No. 2009-008037

### Technical Problem

The spray penetration force of fuel also may increase as a result of a change over time of an internal combustion engine due to reasons such as the accumulation of deposits at, for example, an injection hole of a fuel injection valve. When a configuration is adopted that guides a fuel spray to the periphery of a spark plug utilizing a tumble flow to achieve stratified charge combustion, if the spray penetration force increases due to such a change over time, there is a concern that an unbalance will arise between the strength of the tumble flow and the spray penetration force. If such an unbalance arises, the degree of stratification of the combustible air-fuel mixture at the periphery of the spark plug will decrease at the spark timing. If the degree of stratification decreases, that is, if the air-fuel ratio of the aforementioned air-fuel mixture becomes leaner, combustion fluctuations will increase and torque fluctuations will increase.

According to the technique disclosed in Japanese Patent Laid-Open No. 2002-276421, although the spray penetration force can be reduced by lowering the fuel injection pressure, atomization of fuel will be hindered as a result. Consequently, a problem such as an increase in the amount of fuel that adheres to an in-cylinder wall surface or an increase in carbon monoxide (CO) may arise. It is preferable that countermeasures concerning the restoration of the degree of stratification in a case in which the spray penetration force is increased due to the aforementioned change over time can be performed while mitigating the negative effects on favorable combustion.

### SUMMARY

Preferred embodiments address the above-described problem and have an object to provide an internal combustion engine that is configured, when the spray penetration force of fuel that is injected for stratification is increased due to a change over time, to restore the degree of stratification of a combustible air-fuel mixture at the periphery of a spark plug while mitigating the negative effects on favorable combustion.

An internal combustion engine according to preferred embodiments, in which a tumble flow is generated inside a combustion chamber, includes a spark plug, an in-cylinder injection valve, a variable tumble flow device and a control device. The spark plug is arranged at a central part of a wall surface of the combustion chamber on a cylinder head side. The in-cylinder injection valve is configured to inject fuel at a specific timing so that, when stratified charge combustion operation is performed, a fuel spray proceeds towards a vortex center of the tumble flow. The variable tumble flow device is configured to make a strength of a tumble flow variable. The control device is configured, when a spray penetration force of fuel that is injected by the in-cylinder injection valve is increased due to a change over time of the internal combustion engine, to control the variable tumble flow device so as to increase the strength of the tumble flow during the stratified charge combustion operation.

The control device may be configured, when the spray penetration force is increased due to the change over time, to increase the strength of the tumble flow with the variable tumble flow device during the stratified charge combustion operation until an air-fuel ratio index value that has a correlation with a plug-periphery air-fuel ratio that is an air-fuel ratio of an air-fuel mixture at a periphery of the spark plug at an spark timing stops changing to a rich side.

The control device may be configured to control the variable tumble flow device so as to increase the strength of the tumble flow during the stratified charge combustion operation as a degree of an increase in the spray penetration force due to the change over time is larger.

The control device may be configured, when the spray penetration force is increased due to the change over time and a size of a combustion fluctuation during the stratified charge combustion operation is greater than or equal to a determination value, to increase the strength of the tumble flow with the variable tumble flow device.

The variable tumble flow device may include a tumble control valve that is arranged in an intake passage of the internal combustion engine and configured to control a flow of an intake air that generates a tumble flow. The tumble control valve may be configured, in a state in which the tumble control valve is operated so as to close the intake passage, to increase a flow rate of intake air in a portion on an outer side of a flow path cross-sectional surface of the intake passage as compared to a portion on a center side thereof in a direction perpendicular to an axis line of an intake valve when viewing the combustion chamber from the cylinder head side in a direction of an axis line of a cylinder.

The control device may be configured, when an air-fuel ratio index value that has a correlation with a plug-periphery air-fuel ratio that is an air-fuel ratio of an air-fuel mixture at a periphery of the spark plug at an spark timing changes to a rich side as a result of the spray penetration force of fuel injection that is performed at the specified timing being decreased, to control the variable tumble flow device so as to increase the strength of the tumble flow during the stratified charge combustion operation.

According to the internal combustion engine of preferred embodiments, when the spray penetration force of fuel that is injected by the in-cylinder injection valve is increased due to a change over time during a period in which the stratified charge combustion operation is performed while performing fuel injection using the in-cylinder injection valve so that a fuel spray proceeds to the vortex center of the tumble flow, the tumble control valve is controlled so as to increase the strength of the tumble flow. Therefore, the degree of stratification of a combustible air-fuel mixture at the periphery of the spark plug can be restored while mitigating negative effects on favorable combustion, as compared to a case in which the spray penetration force is adjusted by changing a parameter (for example, fuel injection pressure) that is accompanied by the negative effects on favorable combustion.

### BRIEF DESCRIPTION OF THE DRAWINGS

FIG. 1 is a schematic diagram for describing the system configuration of an internal combustion engine according to a first embodiment of the present invention;

FIG. 2 is a view of the configuration around a combustion chamber as seen from the cylinder head side in the axis line direction of a cylinder;

FIG. 3A, FIG. 3B and FIG. 3C are views for describing a concrete structure of a TCV;

FIG. 4A and FIG. 4B are views for describing a decrease in the degree of stratification of the plug-periphery air-fuel mixture that is caused by a change over time;

FIG. 5A and FIG. 5B are views for describing other causes concerning which the degree of stratification of the plug-periphery air-fuel mixture decreases as a result of an increase in the spray penetration force due to a change over time;

FIG. 6 is a view for describing a change over time in an optimal injection ratio Rb of an in-cylinder injection valve;

FIG. 7 is a view that represents a relation between a correction amount ΔRb of the optimal injection ratio Rb and the spray penetration force;

FIG. 8 is a flowchart illustrating the flow of control according to the first embodiment of the present invention;

FIG. 9 shows a flowchart that represents the flow of the processing for calculating the spray penetration force based on the correction amount ΔRb of the optimal injection ratio Rb;

FIG. 10 is a view for describing one example of a technique for calculating the plug-periphery air-fuel ratio;

FIG. 11 is a view illustrating the relation between the heat release rate dQ/dθ at the determination timing and the plug-periphery air-fuel ratio;

FIG. 12 is a view for describing the setting of the required TCV opening degree OPr based on the spray penetration force;

FIG. 13A, FIG. 13B and FIG. 13C are views for describing the effects on improvement of the degree of stratification that is obtained by the control of the airflow distribution that is realized by closing the TCV;

FIG. 14 is a view for describing restoration operation to restore the degree of stratification of a plug-periphery air-fuel mixture according to a second embodiment of the present invention, which is performed when the spray penetration force is increased due to a change over time;

FIG. 15 is a flowchart illustrating the flow of control according to the second embodiment of the present invention;

FIG. 16 is a time chart that represents one example of results of performance of the processing according to the flowchart shown in FIG. 15;

FIG. 17 is a schematic view for describing the system configuration of an internal combustion engine that includes another variable tumble flow device according to the present application;

FIG. 18 is a view for illustrating the detailed configuration of each protruded portion shown in FIG. 17;

FIG. 19 is a cross-sectional view of a configuration around each intake port, taken along the line K-K in FIG. 18; and

FIG. 20 is a view that illustrates the manner in which a reverse tumble flow that descends on the intake side and ascends on the exhaust side is generated inside the combustion chamber.

### DETAILED DESCRIPTION

### First Embodiment

### Configuration of First Embodiment

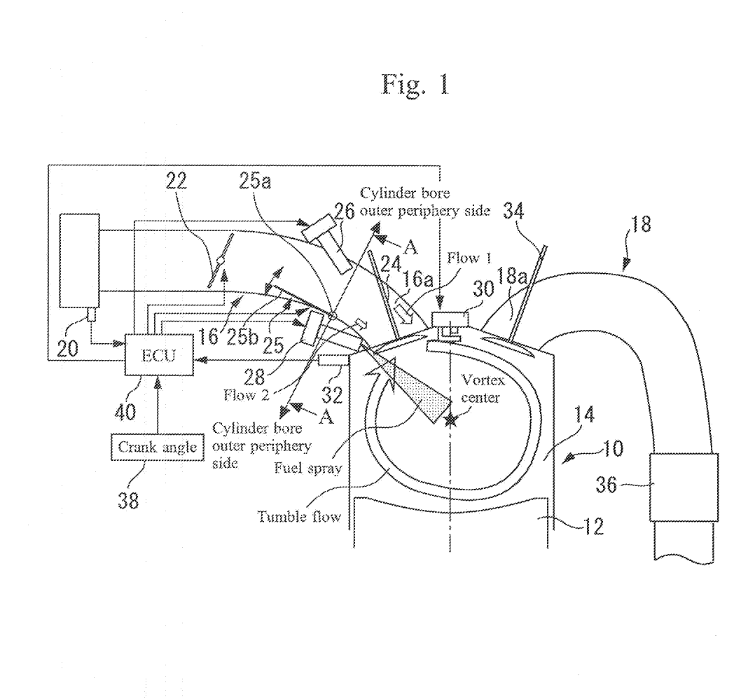

FIG. 1 is a schematic diagram for describing the system configuration of an internal combustion engine 10 according to a first embodiment of the present invention. The system of the present embodiment includes the spark-ignition-type internal combustion engine 10. A piston 12 is provided in each cylinder of the internal combustion engine 10. A combustion chamber 14 is formed on the top side of the piston 12 inside the cylinder. An intake passage 16 and an exhaust passage 18 communicate with the combustion chamber 14.

An air flow meter 20 for measuring an intake air flow rate is arranged in the vicinity of the inlet of the intake passage 16. An electronically controlled throttle valve 22 is also provided in the intake passage 16. The throttle valve 22 can adjust an intake air flow rate by the opening degree of the throttle valve 22 being adjusted in accordance with an accelerator position.

An intake port 16a that is a site in the intake passage 16 at which the intake passage 16 is connected to the combustion chamber 14 is formed so as to generate a vertically rotating vortex, that is, a tumble flow, inside the combustion chamber 14 by the flow of intake air. More specifically, the tumble flow that is generated in the present embodiment is, as illustrated in FIG. 1, a forward tumble flow that ascends on the intake side and descends on the exhaust side. The intake port 16 is configured, in order to generate such a forward tumble flow, so that the flow of intake air at a location on the cylinder bore center side in FIG. 1 (see “Flow 1” in FIG. 1) is stronger than the flow of intake air at a location on the opposite side (that is, the cylinder bore outer periphery side) of the aforementioned location (see “Flow 2” in FIG. 1).

Intake valves 24, each of which opens and closes the intake port 16a, are provided in the intake port 16a. Upstream of the intake valve 24, an electronically controlled tumble control valve (TCV) 25 is arranged. The TCV 25 is a valve device of a flap type that includes a valve stem 25a and a valve element 25b which rotates around the valve stem 25a and that changes the flow path area of the intake passage 16.

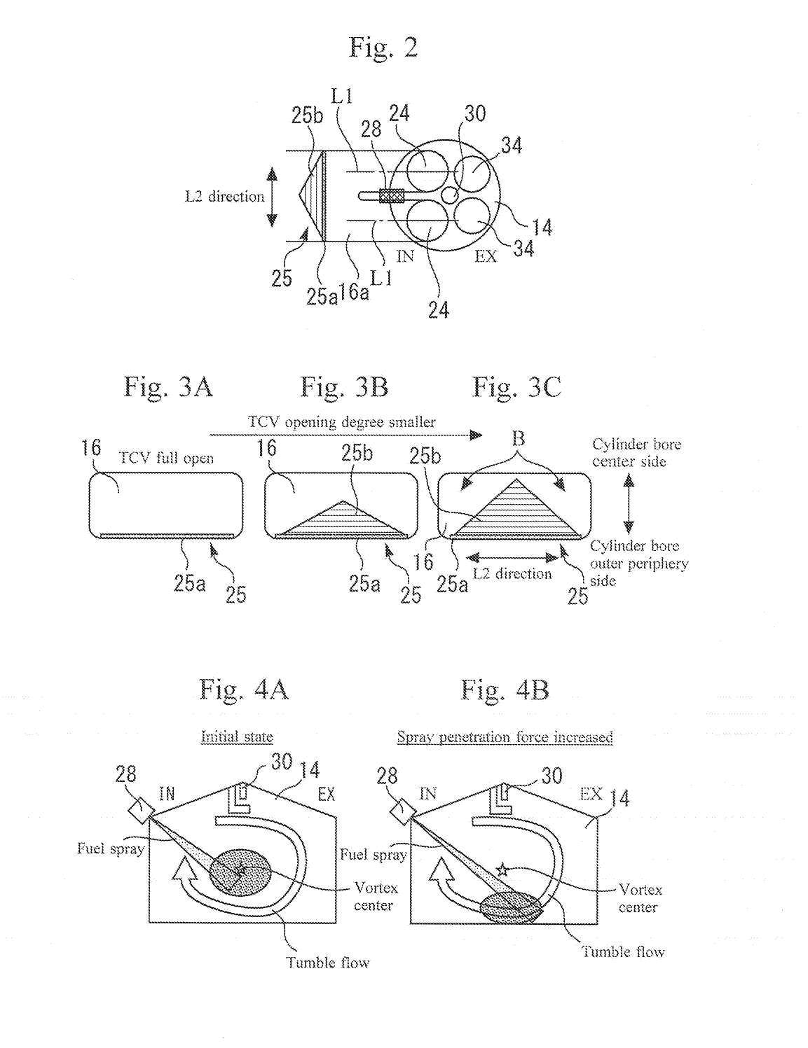

FIG. 2 is a view of the configuration around the combustion chamber 14 as seen from the cylinder head side in the axis line direction of a cylinder. FIG. 3A, FIG. 3B and FIG. 3C are views for describing a concrete structure of the TCV 25, and shows the TCV 25 from the downstream side of the flow of intake air (more specifically, at a flow path cross-sectional surface that is obtained by cutting along the A-A line shown in FIG. 1).

The term “L2 direction” shown in FIG. 2 and FIG. 3C refers to a direction that is perpendicular to an axis line L1 of the intake valve 24 when viewing the configuration around the combustion chamber 14 from the cylinder head side in the axis line direction of the cylinder. In the case of the internal combustion engine 10, the L2 direction becomes parallel to the axis line direction of a crankshaft (not shown in the drawings). In the cylinder of the internal combustion engine 10, two intake valves 24 are arranged so as to adjacent along the L2 direction. As shown in FIG. 2, the TCV 25 is arranged at the upstream side of a branch point at which the intake port 16a branches towards each of the intake valves 24.

The valve stem 25a of the TCV 25 is arranged parallel to the L2 direction in such a manner as to go along a flow path wall surface on the cylinder bore outer periphery side (downstream side in FIG. 1, FIG. 3A, FIG. 3B and FIG. 3C) at the flow path cross-sectional surface of the intake passage 16. FIG. 3A, FIG. 3B and FIG. 3C represent changes in the degree of closing of the intake passage 16 due to a difference of the rotation position of the valve element 25b (that is, the opening degree of the intake passage 16 by the TCV 25 (hereunder, referred as “TCV opening degree OP”)).

As shown in FIG. 3A, in the fully open state, the valve element 25b is inclined along the flow path wall surface. As a result of this, in the fully open state, the TCV 25 does not substantially affect the flow of intake air. On the other hand, according to the TCV 25, the intake passage 16 is closed to a greater degree (that is, the TCV opening degree OP becomes smaller) as the valve element 25b rises to a greater degree.

When viewing the flow path cross-sectional surface in FIG. 3A, FIG. 3B and FIG. 3C while focusing attention on a direction perpendicular to the L2 direction, a portion on the cylinder bore outer periphery side is closed to a greater degree in comparison to a portion on the cylinder bore center side as the TCV opening degree OP becomes smaller. This allows the flow of intake air to change in such a manner in which the intake air is biased to a greater degree towards the cylinder bore center side. As a result, a difference of the flow rate of the flow 1 with respect to the flow rate of the flow 2 can be larger as the TCV opening degree OP is smaller. Therefore, the strength of the tumble flow in the combustion chamber 14 can be increased by decreasing the TCV opening degree OP.

The function that changes the strength of the tumble flow by narrowing a part of the flow path area of an intake passage as described above is a fundamental function which a tumble control valve generally has. On that basis, the TCV 25 additionally has a further function that changes airflow distribution (the bias of the flow of intake air in the L2 direction) in a manner described below.

That is to say, when viewing the flow path cross-sectional surface in FIG. 3A, FIG. 3B and FIG. 3C while focusing attention on the L2 direction, a portion on the center side (inner side) in the L2 direction is closed to a greater degree in comparison to a portion on the outer side thereof. As just described, a difference in the degree of opening of the intake passage 16 is provided between the portion on the center side and the portion of the outer side in the L2 direction. According to such configuration, the bias of the flow of intake air can be generated also in a manner such that a difference of the flow rate of the portion on the outer side with respect to the flow rate of the portion on the center side at the flow path cross-sectional surface in the L2 direction becomes larger as the TCV opening degree OP is smaller.

The valve element 25b has a triangle shape as one example of a valve element shape that is suitable for realizing both of the aforementioned two functions. More specifically, the valve element 25b has a triangle shape by which the height of the valve element 25b becomes maximum at the center in the L2 direction and by which the valve element 25b is formed so as to extend from the apex in this height direction towards the both ends of the valve stem 25a in the intake passage 16. By forming the valve element 25b like this, the flow of intake air can be biased so that, in a state in which the TCV 25 is operated so as to close the intake passage 16 (that is, a state in which the TCV 25 is closed relative to the fully open state), the flow rate at the portion (see two areas shown by arrow B in FIG. 3C) on the cylinder bore center side and the outer side in the L2 direction at the flow path cross-sectional surface becomes larger when the TCV 25 is closed. In other words, by changing the TCV opening degree OP, both of the fundamental function that changes the strength of the tumble flow and the further function that changes the airflow distribution with the aforementioned manner can be favorably obtained.

The explanation of the system configuration of the internal combustion engine 10 is continued with reference to FIG. 1. A port injection valve 26 that injects fuel into the intake port 16a, and an in-cylinder injection valve 28 that directly injects fuel into the combustion chamber 14 are provided in each cylinder of the internal combustion engine 10. A spark plug 30 of an ignition device (not illustrated in the drawings) for igniting an air-fuel mixture is also provided in each cylinder. The spark plug 30 is arranged at a central part of a wall surface of the combustion chamber 14 on the cylinder head side. In addition, an in-cylinder pressure sensor 32 that detects an in-cylinder pressure is provided in each cylinder.

An exhaust port 18a of the exhaust passage 18 is provided with exhaust valves 34, each of which opens and closes the exhaust port 18a. An exhaust gas purification catalyst 36 for purifying exhaust gas is also disposed in the exhaust passage 18. In addition, a crank angle sensor 38 for detecting a crank angle and an engine speed is installed in the vicinity of a crankshaft (not illustrated in the drawings) of the internal combustion engine 10.

The system illustrated in FIG. 1 also includes an electronic control unit (ECU) 40. The ECU 40 includes an input/output interface, a memory, and a central processing unit (CPU). The input/output interface is configured to take in sensor signals from various sensors installed in the internal combustion engine 10 or the vehicle in which the internal combustion engine 10 is mounted, and to also output actuating signals to various actuators for controlling the internal combustion engine 10. Various control programs and maps and the like for controlling the internal combustion engine 10 are stored in the memory. The CPU reads out a control program or the like from the memory and executes the control program or the like, and generates actuating signals for the various actuators based on sensor signals taken in. The sensors from which the ECU 40 takes in signals include various sensors for acquiring the engine operating state, such as the aforementioned air flow meter 20, in-cylinder pressure sensor 32 and crank angle sensor 38. The actuators to which the ECU 40 outputs actuating signals include the aforementioned throttle valve 22, TCV 25, port injection valve 26 and in-cylinder injection valve 28 as well as the aforementioned ignition device.

### (Stratified Charge Combustion Utilizing Tumble Flow)

As described above, by prior selection of the shape of the intake port 16a, the internal combustion engine 10 is configured so that a tumble flow is generated inside the combustion chamber 14. In the present embodiment, in order to realize stratified charge combustion, an air guide method that utilizes the aforementioned tumble flow, that is, a method that transports a fuel spray to the periphery of the spark plug 30 by means of the tumble flow is used. The term “stratified charge combustion” refers to combustion that is performed by forming, in the vicinity of the first spark plug 30 at the spark timing, an air-fuel mixture layer for which the air-fuel ratio is richer than that on the outside thereof. Note that FIG. 1 illustrates a state in the vicinity of 90° C.A before compression top dead center (compression TDC).

To enable the performance of stratified charge combustion using the air guide method, the injection angle of the in-cylinder injection valve 28 is set so that the in-cylinder injection valve 28 can inject fuel towards the vortex center of the tumble flow at a specific timing T in a middle period of the compression stroke. The term “middle period of the compression stroke” used here is preferably 120 to 60° C.A before compression TDC. As one example, the specific timing T here is taken as 90° C.A before compression TDC.

As a technique for injecting fuel when performing stratified charge combustion, according to the present embodiment a technique is used that divides a fuel injection amount that should be injected during a single cycle into a plurality of fuel injection amounts, and uses the port injection valve 26 and the in-cylinder injection valve 28 in a shared manner as fuel injection valves for performing injection of the individual fuel injection amounts after dividing up the fuel injection amount. More specifically, a first fuel injection is performed using the port injection valve 26 and a second fuel injection is performed using the in-cylinder injection valve 28. The first fuel injection is the main fuel injection, and the main part of the amount of fuel that should be injected during a single cycle is injected by the port injection valve 26 in the exhaust stroke or the intake stroke. The second fuel injection is injection of the remaining part of the amount of fuel that should be injected during a single cycle, and is injection of a small amount of fuel that is required for stratification. The second fuel injection is performed by means of the in-cylinder injection valve 28 at the aforementioned specific timing T (90° C.A before compression TDC).

By performing the aforementioned second fuel injection with an appropriate spray penetration force with respect to the strength of the tumble flow, the fuel spray proceeds towards the vortex center of the tumble flow, and as a result the fuel spray becomes wrapped by the tumble flow. The fuel spray that is wrapped by the tumble flow is carried to the periphery of the spark plug 30 accompanying ascent of the piston 12. By this means, gas inside the cylinder can be stratified so that an air-fuel mixture layer that is at the periphery of the spark plug 30 at the spark timing becomes a combustible air-fuel mixture layer for which the air-fuel ratio is richer than that on the outside thereof.

### Control of First Embodiment

### Operating Conditions Subject for Control of the Present Embodiment

The control of the present embodiment that is described hereunder is performed taking fast idle operation as the object thereof. Fast idle operation is performed immediately after a cold start-up of the internal combustion engine 10 in order to maintain the idle rotational speed at a higher speed than the normal idle rotational speed that is used after warming up ends.

### (Advantages of Performing Stratified Charge Combustion at Time of Fast Idle Operation)

In the present embodiment, stratified charge combustion is performed utilizing the aforementioned air guide method at a time of fast idle operation. If stratified charge combustion is performed at a time of fast idling, a combustible air-fuel mixture layer having a higher fuel concentration than that on the outside thereof can be generated at the periphery of the spark plug 30 without significantly enriching the overall air-fuel ratio in the cylinder. Hence, combustion after a cold start-up can be stabilized while reducing fuel consumption.

Further, realization of favorable stratified charge combustion is also effective from the viewpoint of suppressing the discharge of nitrogen oxides (NOx). That is, the generated amount of NOx within a cylinder increases when the air-fuel ratio of the air-fuel mixture that is subjected to combustion is in the vicinity of 16. Raising the degree of stratification of the air-fuel mixture means that the air-fuel ratio of the air-fuel mixture layer at the periphery of the spark plug 30 is enriched. Accordingly, by favorably raising the degree of stratification of the air-fuel mixture at the periphery of the spark plug 30 at the spark timing, formation of an air-fuel mixture layer for which the air-fuel ratio is a value in the vicinity of 16 can be suppressed at the periphery of the spark plug 30 at the spark timing, and thus the generation of NOx can be suppressed. Hereunder, in the present description, to facilitate description of the preferred embodiments, an air-fuel mixture at the periphery of the spark plug 30 around the spark timing is referred to as “plug-periphery air-fuel mixture”, and the air-fuel ratio of the plug-periphery air-fuel mixture is referred to as “plug-periphery air-fuel ratio”.

Further, in the present embodiment, retardation of the spark timing is performed to suppress the discharge of hydrocarbon (HC) and promote warming up of the exhaust gas purification catalyst 36 at the time of fast idle operation. The spark timing retardation control is control that retards the spark timing by a large amount from the optimal spark timing (MBT (minimum spark advance for best torque) spark timing). More specifically, for example, the spark timing is retarded so as to be a timing that is after the compression TDC. By retarding the spark timing by a large amount in this manner and performing combustion, it is possible to promote afterburning of HC in the exhaust passage 18, and also increase the exhaust gas temperature to promote warming up of the exhaust gas purification catalyst 36. In addition, when the spark timing is retarded, ignition generally becomes unstable. However, raising the degree of stratification of the plug-periphery air-fuel mixture also has the effect of stabilizing ignition in a case where this kind of spark timing retardation control is being performed.

### (Issues Related to Stratified Charge Combustion Utilizing Air Guide Method)

The aforementioned air guide method is a method whereby fuel injection is performed so that the fuel spray proceeds towards the vortex center of the tumble flow, and the fuel spray is carried to the periphery of the spark plug 30 in a state in which the fuel spray is wrapped by the tumble flow. In order to enable such an operation AG to be appropriately realized, a configuration is adopted so that the fuel injection at the specific timing T by the in-cylinder injection valve 28 is performed with an appropriate spray penetration force with respect to the strength of the tumble flow that is generated inside the cylinder.

Adjustment of the spray penetration force can be performed by changing a fuel injection ratio. The term “fuel injection ratio” used here refers to a ratio of an amount of fuel for which fuel injection is performed at the specific timing T with respect to the total fuel injection amount that is the total amount of fuel to be injected during a single cycle. In the internal combustion engine 10 of the present embodiment, the total value of the amounts of fuel injected by fuel injection operations performed using the port injection valve 26 and the in-cylinder injection valve 28 during a single cycle corresponds to the aforementioned total fuel injection amount. The ratio of the amount of fuel that is injected at the specific timing T with respect to the total fuel injection amount corresponds to the aforementioned fuel injection ratio (hereunder, referred to as “in-cylinder injection ratio R”).

The spray penetration force increases as the amount of fuel injection at the specific timing T increases. An in-cylinder injection ratio R that can make the balance between the strength of the tumble flow and the spray penetration force an appropriate balance that is required to realize the above-described operation AG is stored as an initial value (adaptive value) Rb0 in the ECU 40. If the balance between the strength of the tumble flow and the spray penetration force is the optimal balance with regard to realizing the above-described operation AG, the degree of stratification of the plug-periphery air-fuel mixture can be increased most, and as a result it is possible to favorably enrich the plug-periphery air-fuel ratio.

FIG. 4A and FIG. 4B are views for describing a decrease in the degree of stratification of the plug-periphery air-fuel mixture that is caused by a change over time. Note that, FIG. 4A and FIG. 4B illustrate states inside a cylinder at a central cross-section that passes through an axis line of the cylinder.

In the initial state in which a change over time of the internal combustion engine 10 has not occurred, as shown in FIG. 4A, the strength of the tumble flow and the spray penetration force are properly balanced when the initial value Rb0 is used as the in-cylinder injection ratio R. As a result of this, the fuel spray appropriately becomes wrapped by the tumble flow.

Here, the spray penetration force can change as a result of a change over time concerning component parts of the internal combustion engine 10, such as the in-cylinder injection valve 28. More specifically, with respect to the spray penetration force, for example, the spray penetration force may sometimes become greater than an initial target value (that is, a value corresponding to the initial value Rb0) due to accumulation of deposits at an injection hole of the in-cylinder injection valve 28. The diagram shown in FIG. 4B represents a state in which the spray penetration force is increased over time with respect to an initial target value due to the aforementioned cause. In this state, the spray penetration force becomes too large relative to the strength of the tumble flow. That is to say, the appropriate balance between the strength of the tumble flow and the spray penetration force that is obtained in the initial state is lost. Therefore, as shown in FIG. 4A and FIG. 4B, after the fuel spray passes through the vortex center of the tumble flow, the fuel spray rides on the tumble flow and diffuses. As a result, the degree of stratification of the plug-periphery air-fuel mixture decreases. If the degree of stratification decreases, the plug-periphery air-fuel ratio becomes leaner. As a result, the rate of combustion slows down, and hence the combustion becomes unstable. Torque fluctuations increase when the combustion becomes unstable. Further, the discharged amount of NOx increases due to a decrease in the degree of stratification.

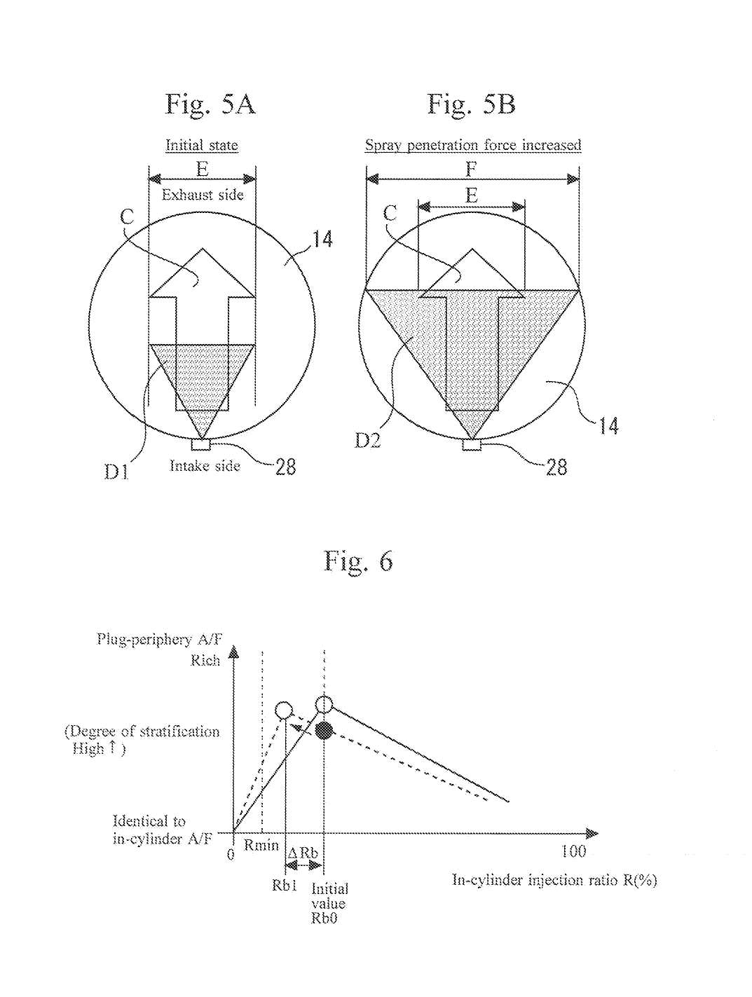

FIG. 5A and FIG. 5B are views for describing other causes concerning which the degree of stratification of the plug-periphery air-fuel mixture decreases as a result of an increase in the spray penetration force due to a change over time. FIG. 5A and FIG. 5B are look-down views of the combustion chamber 14 as seen from the cylinder head side in the axis line direction of a cylinder. An arrow shown with “C” in FIG. 5A and FIG. 5B represents the main flow of the tumble flow (a portion at which the flow velocity is higher than that of the other portions of the tumble flow). In addition, figures shown with “D1” and “D2” in FIG. 5A and FIG. 5B represents a spray of fuel that is injected at the specified timing T for the stratification.

As seen from the cylinder head side (as seen from above of the cylinder), the main flow C of the tumble flow flows to the exhaust side from the intake side through the portion on the cylinder bore center side. The in-cylinder injection valve 28 injects fuel at an injection angle that is defined in terms of its structure. If the in-cylinder injection ratio R is set to an appropriate value (initial value Rb0) for the stratification, as shown in FIG. 5A and FIG. 5B, the fuel spray D1 of fuel that is injected in the initial state in which an increase in the spray penetration force due to a change over time has not occurred is spread at the same level as the width E of a region through which the main flow C of the tumble flow passes.

On the other hand, a spray length of the fuel spray D2 in a state in which an increase in the spray penetration force due to a change over time is occurred is larger than that of the fuel spray D1. As a result of this, the fuel spray D2 is spread to a greater degree as compared to the width E of the region through which the main flow C of the tumble flow passes. More specifically, the fuel spray is spread up to a portion on the outer side relative to the main flow C in the rotation shaft direction of the tumble flow (a portion where a flow component, the flow velocity of which is lower than that of the main flow C, is present). Concerning such fuel spray that is spread out from the width E relating to the main flow C of the tumble flow, it is difficult for the fuel spray to be wrapped inside the tumble flow up to the spark timing. If the amount of fuel spray that is spread out like this becomes larger, the degree of stratification decreases. When the spray penetration force is increased due to a change over time, the degree of stratification decreases not only the cause that is described with reference to FIG. 4A and FIG. 4B but also a cause that is just described.

### Characteristic Portion of Control According to First Embodiment

In the present embodiment, in order to address the above described issues, it is determined, during a fast idle operation in which the stratified charge combustion using the air guide method is performed, whether or not the spray penetration force has been increased due to a change over time of the internal combustion engine 10. If, as a result, it is determined that the spray penetration force has been increased, the TCV 25 is closed to improve the balance between the strength of the tumble flow and the spray penetration force by increasing the strength of the tumble flow.

More specifically, as already described, the internal combustion engine 10 according to the present embodiment produces the bias of the flow of intake air by utilizing the shape of the intake port 16a to generate the tumble flow in the combustion chamber 14. Therefore, in the initial state in which an increase in the fuel penetration force due to a change over time has not occurred, the TCV 25 is put in the fully open state. On that basis, in a case in which an increase in the spray penetration force due to a change over time is recognized, the TCV 25 is closed from the fully open state. In this case, the TCV 25 is closed to a greater degree as the degree of an increase in the spray penetration force is larger. The opening degree of the TCV 25 that is determined like this is used at the time of fast idle operation that is to be performed thereafter. Note that, when an increase in the spray penetration force due to a change over time is detected again after such control to close the TCV 25 is performed, The TCV 25 is closed further in comparison with the opening degree that was determined at the time when the control was previously performed.

### (Method of Determining an Increase in Spray Penetration Force Due to a Change Over Time)

Determination of an increase in the spray penetration force due to a change over time of the internal combustion engine 10 (for example, the in-cylinder injection valve 28) can be performed using, for example, the following method, although any other method can be used for the determination.

FIG. 6 is a view for describing a change over time in an optimal injection ratio Rb of the in-cylinder injection valve 28. FIG. 6 illustrates the relation between the plug-periphery air-fuel ratio and the in-cylinder injection ratio R. As described above, the spray penetration force increases as the amount of fuel injected at the specific timing T increases (that is, as the in-cylinder injection ratio R increases).

A solid line shown in FIG. 6 indicates a characteristic when the internal combustion engine 10 is in an initial state in which a change over time has not occurred. When the in-cylinder injection ratio R is zero, the air-fuel mixture in the cylinder is not stratified, and hence the plug-periphery air-fuel ratio is equal to the air-fuel ratio in the cylinder (that is, a supply air-fuel ratio that is defined by the intake air amount and the fuel injection amount). A “minimum injection ratio Rmin” shown in FIG. 6 is the in-cylinder injection ratio R at a time when the fuel injection amount of the in-cylinder injection valve 28 is a minimum injection amount. The term “minimum injection amount” refers to a value that corresponds to a lower limit value within the control range of the fuel injection amount of the in-cylinder injection valve 28 that is controlled by the ECU 40.

The spray penetration force increases as the in-cylinder injection ratio R increases from the minimum injection ratio Rmin. As a result, accompanying an increase in the in-cylinder injection ratio R, the degree of stratification of the plug-periphery air-fuel mixture increases and the plug-periphery air-fuel ratio is enriched. At a time that the balance between the strength of the tumble flow and the spray penetration force becomes the optimal balance accompanying an increase in the in-cylinder injection ratio R, the fuel spray can be optimally wrapped by the tumble flow. Consequently, the degree of stratification becomes highest at this time, and the plug-periphery air-fuel ratio becomes richest. The in-cylinder injection ratio R at this time is the “optimal injection ratio Rb”. More specifically, the aforementioned initial value Rb0 of the in-cylinder injection ratio R stored in the ECU 40 corresponds to the optimal injection ratio Rb at a time that the strength of the tumble flow is the aforementioned initial target value (design target value), and the spray penetration force of the fuel injection at the optimal injection ratio Rb0 corresponds to the aforementioned initial target value.

If the in-cylinder injection ratio R is increased relative to the optimal injection ratio Rb0 with respect to the solid line shown in FIG. 6, the spray penetration force will increase to exceed the optimal balance and hence the degree of stratification will decrease for a similar reason as in the case that is described above with reference to FIG. 4A, FIG. 4B, FIG. 5A and FIG. 5B.

The optimal injection ratio Rb of the in-cylinder injection ratio R described above changes when the spray penetration force increases due to a change over time. Specifically, as shown in FIG. 6, the optimal injection ratio Rb1 under circumstances in which the spray penetration force is increased due to a change over time changes to a low in-cylinder injection ratio side relative to the initial value Rb0. If the in-cylinder injection ratio R remains at the initial value Rb0 regardless of the fact that such a change over time is occurring, as indicated by a black circular mark in FIG. 6, the degree of stratification decreases in comparison to the degree of stratification (white circular mark) that is obtained under the optimal injection ratio rb1.

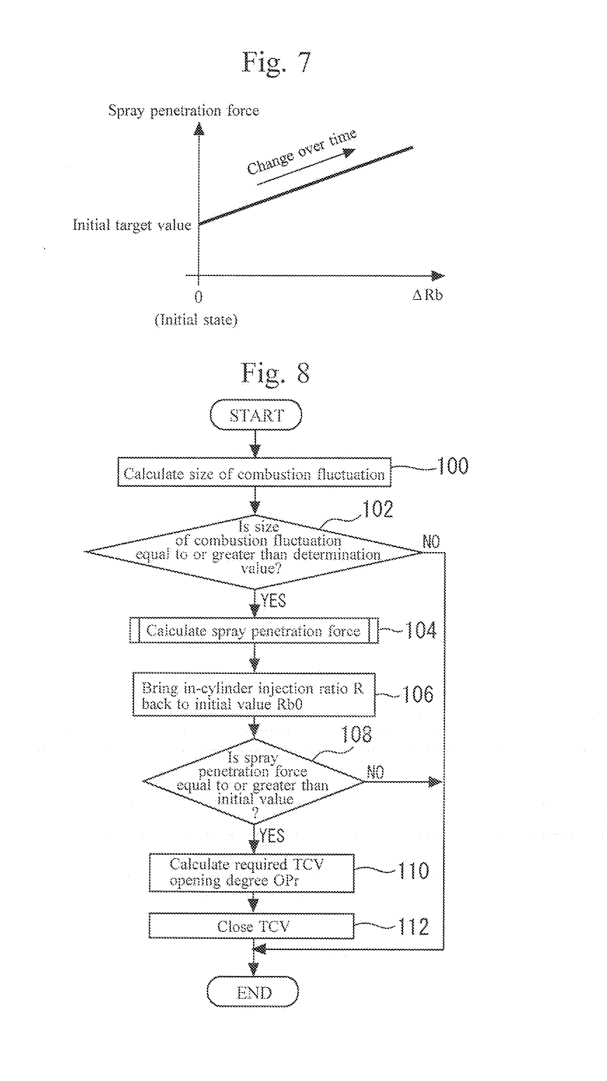

FIG. 7 is a view that represents a relation between a correction amount ΔRb of the optimal injection ratio Rb and the spray penetration force. As the degree of an increase in the spray penetration force due to a change over time is larger, the optimal injection ratio Rb becomes smaller. Accordingly, the relation between the spray penetration force and the correction amount ΔRb (=Rb0−Rb1) that corresponds to a difference between the initial value Rb0 of the optimal injection ratio Rb and the optimal injection ratio Rb1 after a change over time can be represented as shown in FIG. 7. More specifically, when taking the time of the correction amount ΔRb being zero (that is, the time of the fully open state) as a reference, the spray penetration force becomes larger as the correction amount ΔRb becomes larger due to a change over time. Therefore, if a configuration can be adopted such that the relation shown in FIG. 7 is included by adapting it in advance and the correction amount ΔRb of the optimal injection ratio Rb is calculated during fast idle operation that utilizes the stratification charge combustion, the spray penetration force after a change over time can be calculated (estimated) based on the calculated correction amount ΔRb.

### Specific Processing in First Embodiment

FIG. 8 is a flowchart illustrating the flow of control according to the first embodiment of the present invention. The ECU 40 starts the processing of the present flowchart at a time that fast idle operation starts in association with catalyst warm-up control immediately after the internal combustion engine 10 is cold-started. Note that the processing in this flowchart is executed for each cylinder by the ECU 40.

First, in step 100, the ECU 40 calculates the size of a combustion fluctuation. The size of the combustion fluctuation can be calculated by the following technique. That is, for example, data regarding the in-cylinder pressure detected by the in-cylinder pressure sensor 32 is utilized to calculate an indicated mean effective pressure in each cycle, and a variation in the indicated mean effective pressure in a specified plurality of cycles is calculated. This variation may be used as the size of a combustion fluctuation. A configuration may also be adopted in which the crank angle speed is calculated for each cycle utilizing the crank angle sensor 38, and in which a variation in the crank angle speed in a specified plurality of cycles is used as the size of a combustion fluctuation.

Next, the ECU 40 proceeds to step 102. In step 102 the ECU 40 determines whether or not the size of a combustion fluctuation is equal to or greater than a predetermined determination value. The determination value is a value that is set in advance as a value with which it can be determined that the degree of stratification of the plug-periphery air-fuel mixture has decreased by an amount that is equal to or greater than a certain level due to a change over time. If the result determined in the present step 102 is negative, the processing of the present flowchart is promptly ended.

A case where a decrease in the degree of stratification that is equal to or greater than a certain level that is cause by a change over time is not occurring corresponds to a case where a combustion fluctuation of a size equal to or greater than the determination value is not arising in step 102. Further, a case where, even though a change over time is occurring with respect to the spray penetration force, an appropriate balance between the strength of the tumble flow and the spray penetration force is being maintained as a result of also the strength of the tumble flow increasing due to a change over time also corresponds to such a case.

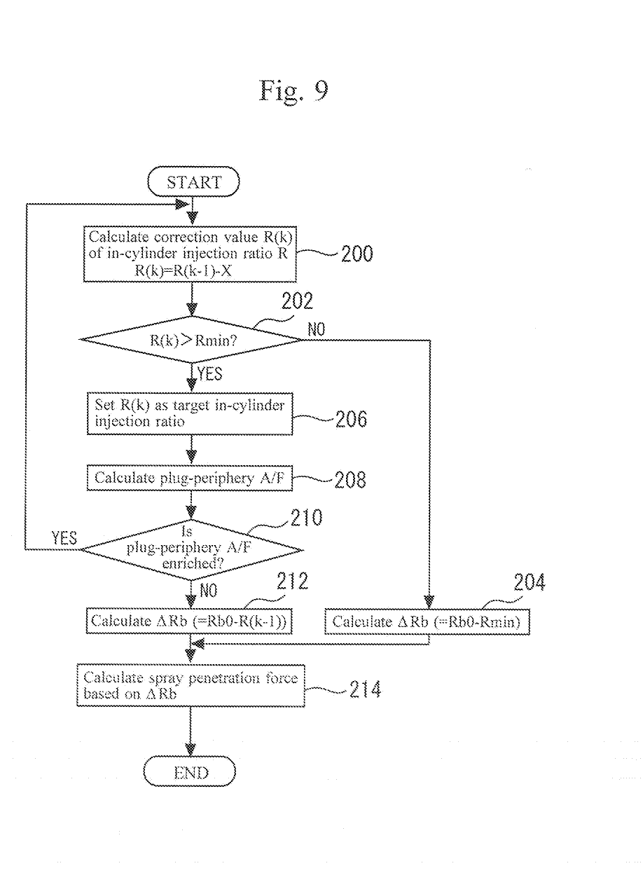

When, on the other hand, the ECU 40 determines in step 102 that a combustion fluctuation of the size equal to or greater than the determination value has arisen, the ECU 40 proceeds to step 104. In step 104, the spray penetration force is calculated. The calculation (estimation) of the spray penetration force can, for example, be executed by the processing according to the following flowchart shown in FIG. 9.

FIG. 9 shows a flowchart that represents the flow of the processing for calculating the spray penetration force based on the correction amount ΔRb of the optimal injection ratio Rb. The processing of this flowchart is based on the method that is described with reference to FIG. 6 and FIG. 7.

First, in step 200, the ECU 40 calculates a correction value R(k) for the in-cylinder injection ratio R. The correction value R(k) is calculated according to the following equation (1).

R(k)=R(k−1)−X (1)

Where, in equation (1), R(k) is a value that is calculated when correcting the in-cylinder injection ratio R a k^{th} time using the above-described initial value Rb0 (that is, an optimal injection ratio that is adapted in advance) of the in-cylinder injection ratio R as R(0). R(k−1) represents the last value. X represents a predetermined fixed amount.

According to the above described equation (1), the correction value (current value) R(k) is calculated as a value that is obtained by subtracting the fixed amount X from the last value R(k−1). In particular, the correction value R(1) that is calculated at the time of the initial (first) correction is obtained by subtracting the fixed amount X from the initial value Rb0 that corresponds to the last value R(0).

Although the fixed amount X is an extremely small amount, it is an amount that is previously determined as a value that can cause a meaningful change in the plug-periphery air-fuel ratio accompanying changing of the in-cylinder injection ratio R. As described hereunder, in order to avoid abrupt changes in the combustion state, changes in the in-cylinder injection ratio R for the purpose of searching for the optimal injection ratio Rb are performed gradually using this kind of fixed amount X.

Next, the ECU 40 proceeds to step 202 to determine whether or not the correction value R(k) calculated in step 200 is greater than the aforementioned minimum injection ratio Rmin. When the result determined in the present step 202 is not affirmative because the correction value R(k) that is calculated this time is equal to or less than the minimum injection ratio Rmin, the ECU 40 proceeds to step 204. In step 204, the correction amount ΔRb of the optimal injection ratio Rb is calculated. In this case, the minimum injection ratio Rmin is regarded as the optimal injection ratio Rb in which the influence of a change over time has been reflected, and the correction amount ΔRb is calculated as a value that is obtained by subtracting the minimum injection ratio Rmin from the initial value Rb0.

On the other hand, when it is determined in step 202 that the correction value R(k) is greater than the minimum injection ratio Rmin, the ECU 40 proceeds to step 206. In step 206, the correction value R(k) calculated in step 200 is set as a target in-cylinder injection ratio. By this means, when the specific timing T arrives from the time point of this setting onwards, in-cylinder injection is performed for the purpose of stratification with a fuel injection amount that is in accordance with the correction value R(k).

Next, the ECU 40 proceeds to step 208. In step 208, the processing is performed to calculate the plug-periphery air-fuel ratio in a state in which the in-cylinder injection ratio R is the correction value R(k). As one example of the calculation processing in the present step 208, the calculation is performed by the following procedure. That is, the in-cylinder injection for stratification that is performed with a fuel injection amount in accordance with the correction value R(k) is performed over a predetermined plurality of cycles Y. The plug-periphery air-fuel ratio is calculated in each cycle of the plurality of cycles Y, and the average value of the calculated plug-periphery air-fuel ratios is calculated. The average value calculated in this manner is temporarily stored in a buffer of the ECU 40 so that the average value can be used as a comparison object when further correction of the in-cylinder injection ratio R is performed. According to the above described calculation processing utilizing the average value, the plug-periphery air-fuel ratio in a state in which the correction value R(k) is used can be acquired while reducing the influence of fluctuations in combustion between cycles. However, a method of acquiring the plug-periphery air-fuel ratio in a state in which the correction value R(k) is used is not limited to a method that utilizes an average value as described above, and for example a method may be adopted that uses a value for a single cycle among the plurality of cycles Y. Alternatively, a method may be adopted in which combustion is performed in a state in which the correction value R(k) is used in only a single cycle, not in the plurality of cycles Y, and in which the plug-periphery air-fuel ratio in the cycle is used.

For example, the following technique can be used for calculation of the plug-periphery air-fuel ratio in each cycle. FIG. 10 is a view for describing one example of a technique for calculating the plug-periphery air-fuel ratio, and shows the relation between a heat release rate dQ/dθ and the crank angle. The ECU 40 can acquire data regarding the in-cylinder pressure in synchrony with the crank angle by utilizing the in-cylinder pressure sensor 32 and the crank angle sensor 38. The ECU 40 can use the data regarding the in-cylinder pressure that is acquired in synchrony with the crank angle to calculate data for the heat release rate dQ/dθ in the cylinder in synchrony with the crank angle according to the following equations (2) and (3).

$$\begin{matrix}d Q = d U + d W & ( 2 ) \\ d Q / d θ = \frac{1}{κ - 1} \times ( V \times \frac{d P}{d θ} + P \times κ \times \frac{d V}{d θ} ) & ( 3 )\end{matrix}$$

Where, equation (2) represents the first law of thermodynamics. In equation (2), U represents internal energy, and W represents work. Further, in equation (3), κ represents the ratio of specific heat, V represents the in-cylinder volume, P represents the in-cylinder pressure, and θ represents the crank angle.

As shown in FIG. 10, the waveform of the heat release rate dQ/dθ changes in accordance with the plug-periphery air-fuel ratio. More specifically, since the combustion becomes slower as the plug-periphery air-fuel ratio becomes leaner, a rise in the heat release rate dQ/dθ becomes slow. Accordingly, by determining the size of the heat release rate dQ/dθ by taking a crank angle that is retarded by a predetermined crank angle period relative to the spark timing (SA) as a predetermined determination timing, the plug-periphery air-fuel ratio can be estimated based on the heat release rate dQ/dθ. More specifically, a favorable crank angle timing as the aforementioned determination timing is a timing at which a rise in the heat release rate dQ/dθ can be determined, and is a timing that is further on the advanced side than a position at which the heat release rate dQ/dθ exhibits a peak value in a case where combustion is performed with the richest plug-periphery air-fuel ratio within a range of fluctuations in the plug-periphery air-fuel ratio that is assumed when the in-cylinder injection ratio R is changed.

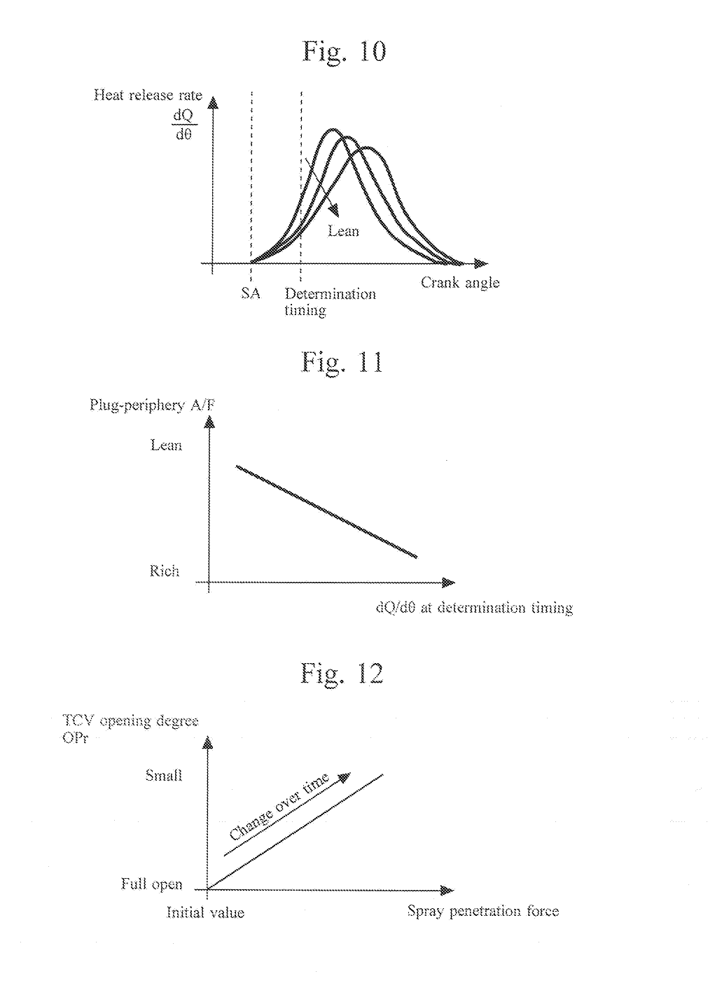

FIG. 11 is a view illustrating the relation between the heat release rate dQ/dθ at the determination timing and the plug-periphery air-fuel ratio. A map that is based on the findings described above with reference to FIG. 10 is stored in the ECU 40 for calculating the plug-periphery air-fuel ratio. According to this map, as shown in FIG. 11, the higher that the heat release rate dQ/dθ is at the determination timing, the richer the value that the plug-periphery air-fuel ratio is set to. In step 208, the plug-periphery air-fuel ratio is calculated by referring to such a map.

In an internal combustion engine that includes an in-cylinder pressure sensor, calculation of the heat release rate dQ/dθ is generally performed for each cycle for the purpose of combustion analysis of the respective cycles. As described above with reference to FIG. 10, the influence of the plug-periphery air-fuel ratio in the respective cycles is reflected in the data for the heat release rate dQ/dθ that is calculated for each cycle. Consequently, according to the technique that is described so far with reference to FIG. 10 and FIG. 11, the plug-periphery air-fuel ratio that is utilized in the control of the present embodiment can be easily and accurately estimated by utilizing such kind of heat release rate dQ/dθ.

Next, the ECU 40 proceeds to step 210. In step 210, the ECU 40 determines whether or not the current value A/F(k) that is (the average value of) the plug-periphery air-fuel ratio under combustion using the correction value R(k) has become richer relative to a last value A/F(k−1) that is the plug-periphery air-fuel ratio under the combustion immediately prior to the current correction of the in-cylinder injection ratio R. More specifically, it is determined whether or not a difference obtained by subtracting the current value A/F(k) from the last value A/F(k−1) is equal to or greater than a predetermined value. The predetermined value is a value that is set in advance as a value with which it is possible to determine a change in the plug-periphery air-fuel ratio accompanying a change in the in-cylinder injection ratio R by the fixed amount X. Note that, as the last value A/F(k−1), with regard to correction from the second time onwards, the value that is calculated and stored in the buffer in step 208 is used. With regard to the initial correction, for example, a plug-periphery air-fuel ratio in a plurality of cycles or a single cycle utilized for calculating the size of a combustion fluctuation in step 100 in FIG. 8 can be calculated and stored in the buffer, and the stored value can be used.

In a case where enrichment of the plug-periphery air-fuel ratio is recognized in step 210, the ECU 40 repeats execution of the processing from step 200 onwards. In contrast, when meaningful enrichment concerning the plug-periphery air-fuel ratio is not recognized in step 210, that is, when the plug-periphery air-fuel ratio stops exhibiting a change to the rich side as a result of a change in the in-cylinder injection ratio R, the ECU 40 proceeds to step 212. In step 212, the correction amount ΔRb is calculated. In this case, the in-cylinder injection ratio R prior to the most recent correction, that is, the last value R(k−1), is regarded as the optimal injection ratio Rb (more specifically, Rb1) in which the current correction by execution of the processing of the flowchart has been reflected, and the correction amount ΔRb is calculated as a value that is obtained by subtracting the last value R(k−1) from the initial value Rb0.

After executing the processing of step 212 or step 204, the ECU 40 proceeds to step 214. In the ECU 40, the relation between the spray penetration force and the correction amount ΔRb as represented in FIG. 7 is defined in advance and stored as a map. In step 214, the spray penetration force that corresponds to the correction amount ΔRb calculated in step 212 is calculated with reference to such a map. The spray penetration force after a change over time is calculated in this way, and as a result, the execution of the processing of the flowchart shown in FIG. 9 is ended.

Explanation of the flowchart shown in FIG. 8 is continued again. After calculating the spray penetration force in step 104, the ECU 40 proceeds to step 106. In step 106, processing to bring, back to the initial value Rb0, the in-cylinder injection ratio R that was changed for the calculation of the spray penetration force is executed. Accordingly, the initial value Rb0 is used again for the fuel injection performed when the specified timing T arrives from the execution timing of this processing onwards.

Next, the ECU 40 proceeds to step 108. In step 108, it is determined whether or not the spray penetration force that is calculated in step 104 is greater than or equal to the initial value (the aforementioned initial target value). As a result of this, when the result determined in step 108 is negative, the ECU 40 ends the execution of the current processing of the flowchart.

On the other hand, when the result determined in step 108 is affirmative, that is, when it can be judged that the spray penetration force is increased due to a change over time, the ECU 40 proceeds to step 110. In step 110, a required TCV opening degree OPr is calculated. The required TCV opening degree OPr refers to a TCV opening degree OP that is required to properly restore the degree of stratification that has decreased due to a change over time.

FIG. 12 is a view for describing the setting of the required TCV opening degree OPr based on the spray penetration force. When the spray penetration force is increased with respect to a state in which an appropriate balance between the strength of the tumble flow and the spray penetration force is kept, the degree of stratification decreases to a greater degree as the degree of an increase in the spray penetration force is larger. In addition, by increasing the strength of the tumble flow, the balance between the strength of the tumble flow and the spray penetration force can be improved. FIG. 12 shows the required TCV opening degree OPr for improving the balance with the relation between the required TCV opening degree OPr and the spray penetration force. The required TCV opening degree OPr is set so as to be smaller as an increase in the spray penetration force with respect to the initial value is larger. In the ECU 40, a relation between the required TCV opening degree OPr and the spray penetration force as shown in FIG. 12 is defined in advance and stored as a map. In step 110, the required TCV opening degree OPr according to the spray penetration force that is calculated in step 104 is calculated with reference to such a map.

Next, the ECU 40 proceeds to step 112. In step 112, processing to close the TCV 25 so as to obtain the required TCV opening degree OPr that is calculated in step 110 is executed. Then, the execution of the processing of the flowchart shown in FIG. 8 is ended. In further addition to that, the required TCV opening degree OPr that has been obtained by the processing according to the present flowchart is continuously used during a period in which fast idle operation is continuously performed after an engine startup that is a target of execution of the current processing according to the flowchart. In addition, as to also the time of fast idle operation after the next engine startup or an engine startup performed thereafter, the required TCV opening degree OPr that is currently obtained is continuously used as far as the required TCV opening degree OPr is not updated by the processing according to the flowchart shown in FIG. 8.

### Effects of Control According to First Embodiment

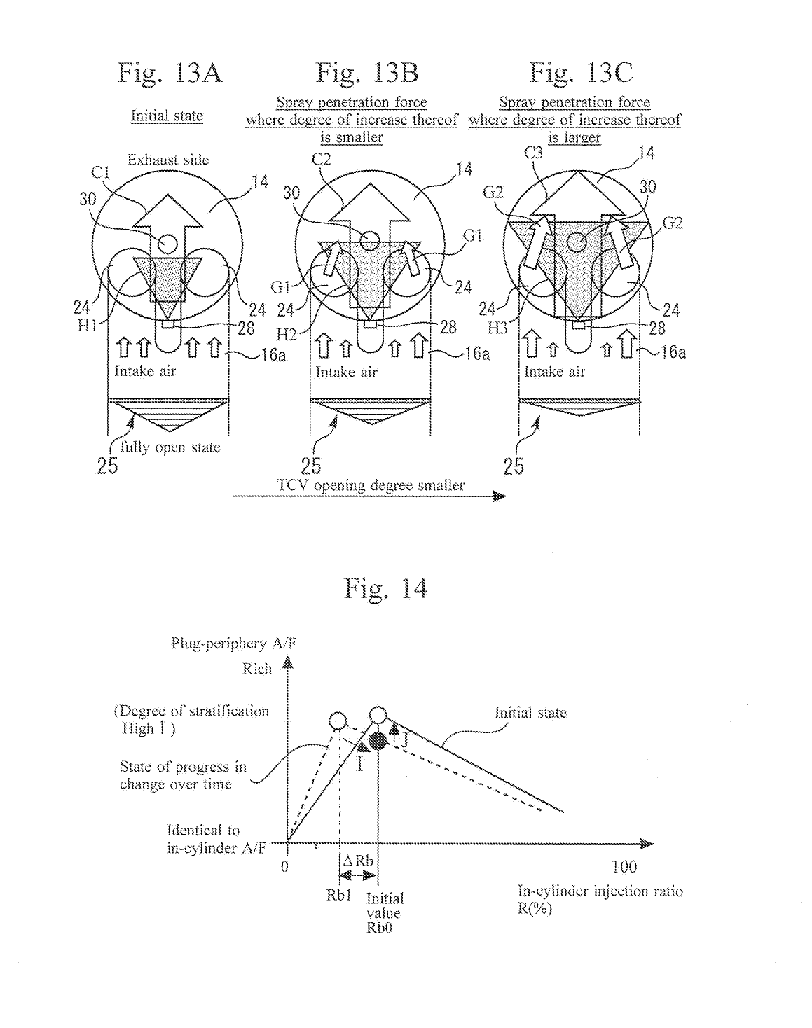

In the processing according to the flowchart shown in FIG. 8, when the spray penetration force is increased due to a change over time, the strength of the tumble flow that is generated in the combustion chamber 14 is increased by closing the TCV 25 (see the main flows C1 to C3 of the tumble flow in FIG. 13A, FIG. 13B and FIG. 13C described later). This allows the balance between the strength of the tumble flow and the spray penetration force to be improved in the internal combustion engine 10 that adopts the air guide method by which fuel injection is performed so that the fuel spray proceeds towards the vortex center of the tumble flow and by which the fuel spray is carried to the periphery of the spark plug 30 in a state in which the fuel spray is wrapped by the tumble flow. As a result of this, the degree of stratification of the plug-periphery air-fuel mixture that has been decreased accompanying an increase in the spray penetration force due to a change over time can be restored. More specifically, according to the adjustment of the strength of the tumble flow by the TCV 25, the degree of stratification of the plug-periphery air-fuel mixture can be restored while mitigating the negative effects on favorable combustion, in comparison to a case in which the spray penetration force is adjusted by changing a parameter (for example, fuel injection pressure) associated with the negative effects on favorable combustion. In addition, by restoring the degree of stratification, an increase in a torque fluctuation and an increase in NOx emission can be suppressed.

Moreover, the internal combustion engine 10 according to the present embodiment utilizes the TCV 25 of a shape that is described with reference to FIG. 3A, FIG. 3B and FIG. 3C. According to the TCV 25 including such configuration, the effects that is described below with reference to FIG. 13A, FIG. 13B and FIG. 13C can also be achieved by not only the above described strengthening of the tumble flow but also the further function that changes the airflow distribution (the bias of the flow of intake air in the L2 direction).

FIG. 13A, FIG. 13B and FIG. 13C are views for describing the effects on improvement of the degree of stratification that is obtained by the control of the airflow distribution that is realized by closing the TCV 25. In the initial state, the TCV 25 is fully opened. Because of this, a bias of the flow of intake air in the intake port 16a does not occur as shown in the diagram in FIG. 13A. An arrow shown with “C1” corresponds to the main flow of the tumble flow in the initial state.

On the other hand, as shown in the diagram in FIG. 13B, in a state in which the TCV opening degree OP is controlled on the closing side relative to the full opening degree, a bias of the flow of intake air in the intake port 16a occurs in the L2 direction. This bias acts such that, in the L2 direction, the flow rate of a portion on the outer side is increased relative to the flow rate of a portion on the center side. Generation of such bias can generate, with a meaningful level, a flow component G1 that proceeds towards the portion on the cylinder bore center side through which the main flow C2 passes, when viewing the inside of the combustion chamber 14 from the cylinder head side in the axis line direction of the cylinder. On the other hand, due to an increase in the spray penetration force, a fuel spray H2 is urged to be spread to a greater degree to the cylinder bore outer periphery side as compared with a fuel spray H1 in the initial state. According to the TCV 25 of the present embodiment, the strengthened flow component G1 can suppress the spread of the fuel spray H2 and collect most of the fuel spray H2 to the portion on the cylinder bore center side through which the main flow C2 flows.

Furthermore, the aforementioned change in the airflow distribution in association with a decrease in the TCV opening degree OP becomes larger as the TCV opening degree OP is smaller. That is to say, as shown in the diagram in FIG. 13C, in a state in which the TCV opening degree OP is decreased to a greater degree, a flow component G2 can be strengthened further as compared with the flow component G1. Thus, by decreasing the TCV opening degree OP further as the degree of an increase in the spray penetration force is larger, the spread of a fuel spray H3 that is urged to spread to a greater degree due to a fact that the degree of an increase in the spray penetration force is larger can be suppressed by the strengthened flow component G2. Therefore, even when the degree of an increase in the spray penetration force becomes larger, most of the fuel spray H3 can be collected to the portion on the cylinder bore center side through which the main flow C3 flows.

As described so far, according to the internal combustion engine 10 of the present embodiment, the control of the airflow distribution that has been described with reference to FIG. 13A, FIG. 13B and FIG. 13C can also be performed by closing the TCV 25, and hence, the degree of stratification of the plug-periphery air-fuel mixture can be improved more properly as compared with a case in which only the strengthening of the tumble flow is performed.

Moreover, according to the control of the present embodiment, the required TCV opening degree OPr is calculated to be smaller as the degree of an increase in the spray penetration force due to a change over time is larger. Therefore, during the stratified charge combustion operation, the strength of the tumble flow can be increased to a greater degree as the degree of an increase in the spray penetration force is larger. As a result of this, the degree of stratification can be properly restored while taking into account the degree of an increase in the spray penetration force due to a change over time.

Moreover, according to the above described processing in the flowchart shown in FIG. 8, when the spray penetration force is increased due to a change over time and the size of a combustion fluctuation during the stratified charge combustion operation is greater than or equal to the determination value, the TCV 25 is closed. In other words, when the size of a combustion fluctuation is not greater than the determination value although the spray penetration force is increased due to a change over time, the control of the TCV 25 is not performed. As already described, a case in which, even though a change over time is occurring with respect to the spray penetration force due to a change over time, an appropriate balance between the strength of the tumble flow and the spray penetration force is being maintained as a result of also the strength of the tumble flow increasing over time corresponds to one of cases in which the size of a combustion fluctuation is not greater than the determination value. In this case, if the strength of the tumble flow is increased by closing the TCV 25 simply because the spray penetration force is increased, an appropriate balance between the strength of the tumble flow and the spray penetration force will be, on the contrary, lost. In contrast, the processing according to the present embodiment can avoid losing the balance in such a case.

Furthermore, in the control according to the present embodiment, changing the in-cylinder injection ratio R is not used as means for restoring the degree of stratification that has been decreased due to an increase in the spray penetration force, although it is utilized for the purpose of detecting an increase in the spray penetration force due to a change over time. When the spray penetration force is increased due to a change over time, the degree of stratification can be restored by decreasing the in-cylinder injection ratio R (in other words, the plug-periphery air-fuel ratio can be enriched). However, as will be understood by comparing the plug-periphery air-fuel ratios of two white circle marks shown in FIG. 6, if the in-cylinder injection ratio R is decreased to restore the degree of stratification, the plug-periphery air-fuel ratio under the optimal injection ratio Rb1 after a change over time becomes leaner than that under the initial value Rb0. Accordingly, the method whereby the in-cylinder injection ratio R is decreased has an insufficient aspect when the degree of stratification is urged to be restored to keep the plug-periphery air-fuel ratio in a rich state. In contrast, according to the method of the present embodiment that utilizes the TCV 25, the degree of stratification can be restored without changing the in-cylinder injection ratio R, and thus, the plug-periphery air-fuel ratio can be properly enriched.

Note that, in the above described first embodiment, the ECU 40 that executes the processing according to the flowcharts illustrated in FIG. 8 and FIG. 9 corresponds to “control device” according to the present application.

### Second Embodiment

Next, a second embodiment according to the present invention will be described with reference mainly to FIG. 14 through FIG. 16.

### Control According to Second Embodiment

### Characteristic Portion of Control According to Second Embodiment

The present embodiment is similar to the foregoing first embodiment with regard to the fundamental part thereof that, when the spray penetration force is increased due to a change over time, the TCV 25 is closed in order to increase the strength of the tumble flow. However, the control according to the present embodiment differs from the control according to the first embodiment with respect to a point that is described hereunder referring to FIG. 14.

FIG. 14 is a view for describing restoration operation to restore the degree of stratification of a plug-periphery air-fuel mixture according to a second embodiment of the present invention, which is performed when the spray penetration force is increased due to a change over time. The above described method according to the first embodiment is a method by which the spray penetration force is estimated based on the correction amount ΔRb of the optimal injection ratio Rb and by which the required TCV opening degree OPr according to the estimated spray penetration force is calculated with reference to a map. The method according to the present embodiment is the same as the method according to the first embodiment with respect to a point that an operation (see operation I in FIG. 14) to bring, back to the initial value Rb0, the in-cylinder injection ratio R that is changed to calculate the correction amount ΔRb when it is determined that based on the correction amount ΔRb, the spray penetration force has been increased due to a change over time. Further, according to the method of the present embodiment, after bringing the in-cylinder injection ratio R back to the initial value Rb0, the TCV 25 is gradually closed while monitoring the plug-periphery air-fuel ratio. More specifically, the TCV 25 is continuously closed until the plug-periphery air-fuel ratio stops exhibiting a change to the rich side (see operation J in FIG. 14). According to such method, unlike the method of utilizing a relation of a map that is defined in advance, the required TCV opening degree OPr can be determined more properly while reflecting the influence of the actual combustion state of the internal combustion engine 10.

### Specific Processing in Second Embodiment

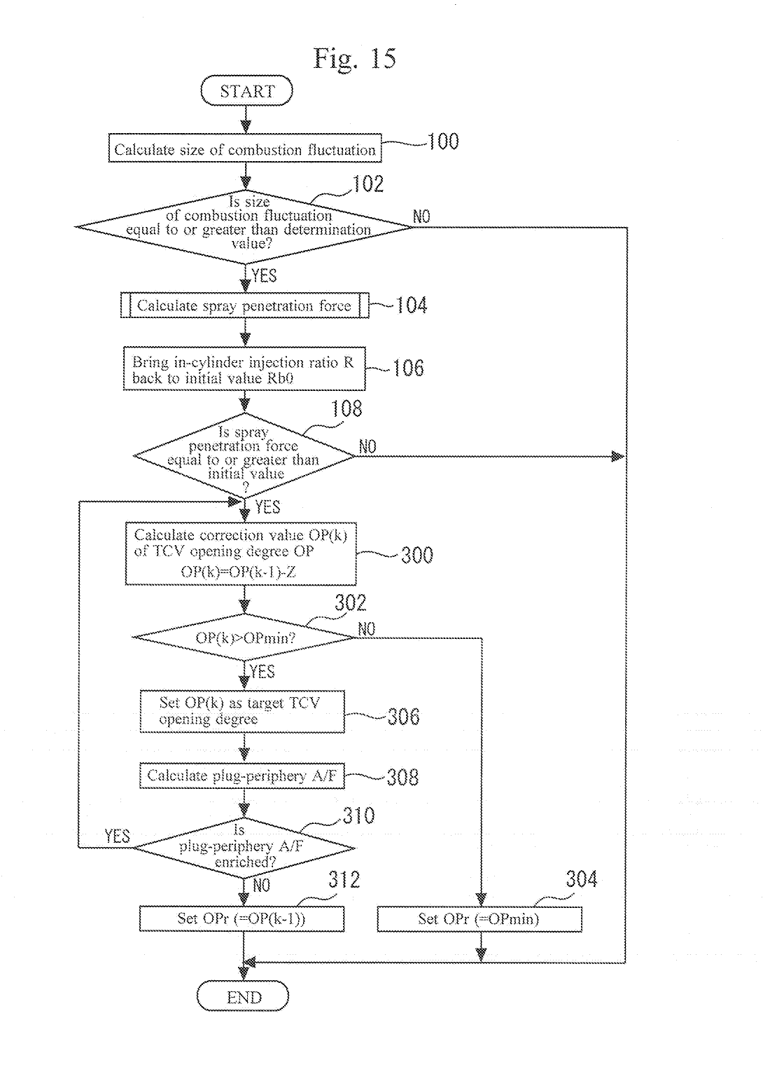

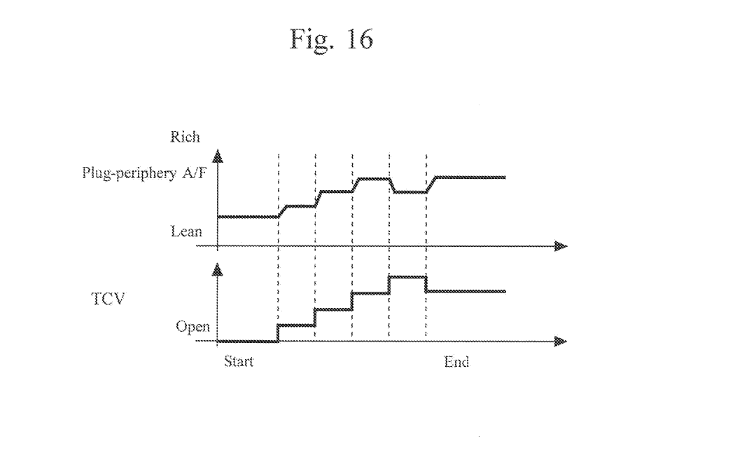

FIG. 15 is a flowchart illustrating the flow of control according to the second embodiment of the present invention. Note that, in FIG. 15, steps that are the same as steps shown in FIG. 8 in the first embodiment are denoted by the same reference numerals, and a description of those steps is omitted or simplified. Further, in the following description relating to the processing of the present flowchart, differences from the processing of the flowchart shown in FIG. 8 are mainly described.

When the ECU 40 determines in step 108 that the spray penetration force is greater than or equal to the initial value, the ECU 40 proceeds to step 300. In step 300, a correction value OP(k) of the TCV opening degree OP is calculated. The correction value OP(k) is calculated according to the following equation (4).

OP(k)=OP(k−1)−Z (4)

Where, in equation (4), OP(k) is a value that is calculated when correcting the TCV opening degree OP a k^{th} time using the initial value (in the case of TCV 25, a full opening degree) of the TCV opening degree OP as OP(0). OP(k−1) represents the last value. Z represents a predetermined fixed amount.

According to the above described equation (4), the correction value (current value) OP(k) is calculated as a value that is obtained by subtracting the fixed amount Z from the last value OP(k−1). In particular, the correction value OP(1) that is calculated at the time of the initial (first) correction is obtained by subtracting the fixed amount Z from the initial value that corresponds to the last value OP(0).

Although the fixed amount Z is an extremely small amount, it is an amount that is previously determined as a value that can cause a meaningful change in the plug-periphery air-fuel ratio accompanying changing of the TCV opening degree OP. As described hereunder, in order to avoid abrupt changes in the combustion state, changes in the TCV opening degree OP for the purpose of searching for the required TCV opening degree OPr are performed gradually using this kind of fixed amount Z.

Next, the ECU 40 proceeds to step 302 to determine whether or not the correction value OP(k) calculated in step 300 is greater than the aforementioned minimum opening degree OPmin within the control range of the TCV opening degree OP. When the result determined in the present step 302 is not affirmative because the correction value OP(k) that is calculated this time is equal to or less than the minimum opening degree OPmin, the ECU 40 proceeds to step 304. In step 304, the minimum opening degree OPmin is set as the required TCV opening degree OPr in which correction by the current execution of the processing according to the flowchart has been reflected.

On the other hand, when it is determined in step 302 that the correction value OP(k) is greater than the minimum opening degree OPmin, the ECU 40 proceeds to step 306. In step 306, the correction value OP(k) calculated in step 300 is set as a target TCV opening degree. By this means, the TCV 25 is driven so that the actual TCV opening degree coincides with such target TCV opening degree.

Next, the ECU 40 proceeds to step 308. In step 308, a calculation processing for the plug-periphery air-fuel ratio in a state in which the actual TCV opening degree is controlled with the correction value OP(k) is performed. This calculation processing can be performed using the similar method to that of the processing of step 208 described above. Next, the ECU 40 proceeds to step 310. In step 310, it is determined whether or not the current value A/F(k) that is (the average value of) the plug-periphery air-fuel ratio under combustion that is performed by using the correction value OP(k) is enriched with respect to the last value A/F(k−1) that is the plug-periphery air-fuel ratio under combustion that is performed immediately before correction of the current TCV opening degree OP. The concrete method of this determination is similar to the above described method of the processing of step 210.

In a case where enrichment of the plug-periphery air-fuel ratio is recognized in step 310, the ECU 40 repeats execution of the processing from step 300 onwards. In contrast, when meaningful enrichment concerning the plug-periphery air-fuel ratio is not recognized in step 310, that is, when the plug-periphery air-fuel ratio stops exhibiting a change to the rich side as a result of a change in the TCV opening degree OP, the ECU 40 proceeds to step 312. In step 312, the required TCV opening degree OPr is calculated. In this case, the TCV opening degree OP prior to the most recent correction, that is, the last value OP(k−1), is regarded as the optimal TCV opening degree OP in which the current correction by execution of the processing of the flowchart has been reflected, and the last value OP(k−1) is set as the required TCV opening degree OPr.

FIG. 16 is a time chart that represents one example of results of performance of the processing according to the flowchart shown in FIG. 15. According to the processing of the flowchart shown in FIG. 15, when an increase in the spray penetration force due to a change over time is recognized, the TCV opening degree OP is gradually decreased as shown in FIG. 16 during a period in which the plug-periphery air-fuel ratio A/F(k) is exhibiting a change to the rich side. FIG. 16 shows an example in which the plug-periphery air-fuel ratio stops exhibiting a change to the rich side as a result of performing a fourth-time decrease in the TCV opening degree. In this example, the plug-periphery air-fuel ratio exhibits the richest value (A/F(3)) after changing the TCV opening degree OP third times, and hence, the correction value OP(3) at this time is used as the required TCV opening degree OPr to properly restore the degree of stratification that has been decreased due to the current change over time.

According to the control of the present embodiment, which has been described so far, the processing to gradually decrease the TCV opening degree OP is performed until the plug-periphery air-fuel ratio stops exhibiting a change to the rich side. This allows the degree of stratification to be restored so that the degree of stratification becomes highest within a range that can be realized under a state of the current change over time. Therefore, the stratified charge combustion can be stabilized by enriching the plug-periphery air-fuel ratio as much as possible.

Note that, in the above described second embodiment, the ECU 40 that executes the processing according to the flowcharts illustrated in FIG. 15 and FIG. 9 corresponds to “control device” according to the present application.

### Other Embodiments

The foregoing first and second embodiments have been described taking as an example a technique that estimates the plug-periphery air-fuel ratio using the heat release rate dQ/dθ that is calculated utilizing the in-cylinder pressure sensor 32. However, a technique for acquiring the plug-periphery air-fuel ratio according to the present application is not limited to the technique described above, and may be the following kind of technique. That is, an optical sensor is known that is integrated with a spark plug and is capable of detecting a fuel concentration by utilizing an infrared absorption method. For example, the plug-periphery air-fuel ratio may also be a ratio that is detected utilizing the aforementioned optical sensor. Further, an optical sensor that detects light emission of a radical in combustion gas is known. The plug-periphery air-fuel ratio may also be, for example, a ratio that is estimated based on the light emission intensity of a predetermined radical that is calculated utilizing the output of such kind of optical sensor.

In the above-described second embodiment, a configuration is adopted that uses the plug-periphery air-fuel ratio that is calculated based on the size of the heat release rate dQ/dθ at the determination timing, in order to search for an appropriate required TCV opening degree OPr. Further, in the first and second embodiments, the plug-periphery air-fuel ratio is used also to search for the optimal injection ratio Rb to calculate (estimate) the spray penetration force after a change over time. However, a parameter according to the present application, which is used when determining how much the strength of the tumble flow is increased or determining whether or not an increase in the spray penetration force due to a change over time is occurring, is not necessarily limited to a parameter that is acquired as the plug-periphery air-fuel ratio, as long as the parameter is an air-fuel ratio index value that has a correlation with the plug-periphery air-fuel ratio. That is, an air-fuel ratio index value of the present application may be a value that, for example, shows the size of a combustion fluctuation. Although combustion fluctuations deteriorate under an excessively rich combustion air-fuel ratio, it can be said that, within the range of fluctuations in the plug-periphery air-fuel ratio that are assumed at a time of stratified charge combustion operation using the air guide method, the combustion fluctuations decrease as the air-fuel ratio becomes richer. Accordingly, in a case of using, as the aforementioned air-fuel ratio index value, a value that shows a size of a combustion fluctuation, when the spray penetration force is changed and the combustion fluctuation decreases, the air-fuel ratio index value can be regarded as exhibiting a change to the rich side, and conversely, when the combustion fluctuation increases, the air-fuel ratio index value can be regarded as exhibiting a change to the lean side.

Further, in the above-described first and second embodiments, a configuration is adopted which changes the in-cylinder injection ratio R (fuel injection ratio) in order to change the spray penetration force. However, the spray penetration force in the present application may be changed by changing a parameter associated with combustion that is other than the fuel injection ratio (for example, by changing the fuel injection pressure). However, it can be said that a technique that changes the fuel injection ratio is a superior technique from the viewpoint of, for example, atomization of fuel.

The foregoing first and second embodiments have been described taking as an example a technique that uses the in-cylinder injection valve 28 and the port injection valve 26 for fuel injection when performing stratified charge combustion. However, an internal combustion engine that is an object of the present application may be an internal combustion engine which includes only the in-cylinder injection valve, and in which the port injection valve is not provided. Further, the fuel injection that is performed when performing stratified charge combustion in such an internal combustion engine may be divided injection which uses only the in-cylinder injection valve and which divides, into a plurality of fuel injection operations, a fuel injection operation for injecting a fuel injection amount that should be injected during a single cycle. More specifically, the first fuel injection that is the main fuel injection may be performed in the intake stroke, and fuel injection of a small amount that is necessary for stratification may be performed at the specific timing T that is described above referring to FIG. 1.

Further, the foregoing first and second embodiments have been described taking as an example the TCV 25 which includes not only the fundamental function that changes the strength of the tumble flow by narrowing a part of the flow path area of the intake passage and but also the further function that changes airflow distribution (the bias of the flow of intake air in the L2 direction), as described with reference to FIG. 2 and FIG. 3A, FIG. 3B and FIG. 3C. However, the control according to the present application may, for example, be the one which uses a tumble control valve having a general configuration that includes only the fundamental function and that does not include such further function, and which increases the strength of the tumble flow when the spray penetration force is increased due to a change over time. Moreover, in the first and second embodiments, an example has been described in which a base tumble flow is generated by the effects of the shape of the intake port 16a. However, such base tumble flow may be generated by utilizing a tumble control valve having the general configuration, instead of the effects of the shape of an intake port or as well as the effects.

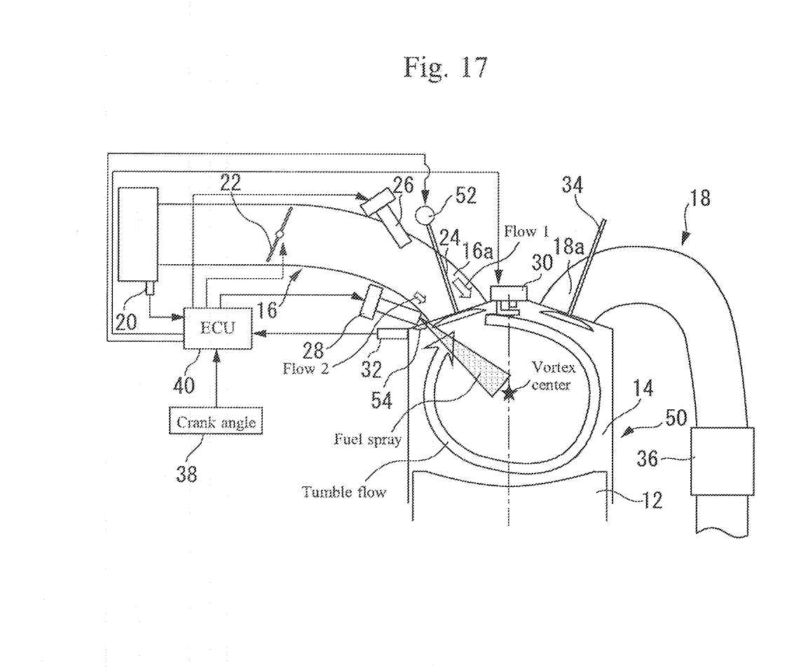

Further, in the first and second embodiments, an example has been described in which the TCV 25 is utilized to make the strength of the tumble flow variable. However, a variable tumble flow device according to the present application is not limited to the configuration that utilizes a tumble control valve, and may, for example, be the one that has a configuration that is described hereunder with reference to FIG. 17 through FIG. 19.

FIG. 17 is a schematic view for describing the system configuration of an internal combustion engine 50 that includes another variable tumble flow device according to the present application. Note that, in FIG. 17, elements that are the same as constituent elements illustrated in the above described FIG. 1 are denoted by the same reference symbols, and a description of those elements is omitted or simplified hereunder.

The internal combustion engine 50 shown in FIG. 17 has a similar configuration to the above described internal combustion engine 10 except that the internal combustion engine 50 includes a variable intake valve operating device 52 and protruded portions 54 and does not include the TCV 25. The variable intake valve operating device 52 is able to continuously change the valve lift of each intake valve 24. A valve operating device having such a function is in itself known, and the description of a specific configuration thereof is omitted here.

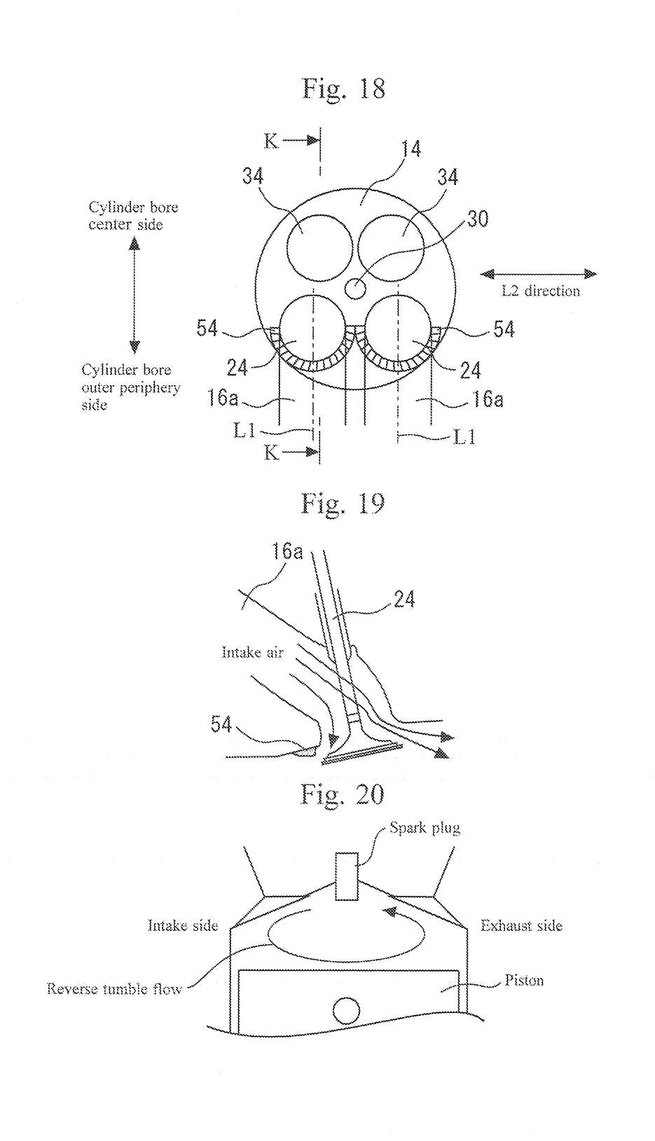

FIG. 18 is a view for illustrating the detailed configuration of each protruded portion 54 shown in FIG. 17. Note that, FIG. 18 is a view of the combustion chamber 14 as seen from below in the axis line of the cylinder. Each protruded portion 54 is formed on the wall surface of the combustion chamber 14 in correspondence with a corresponding one of the intake ports 62a provided two by two for each cylinder. Each protruded portion 54 surrounds the outlet of the corresponding intake port 14a. However, the protruded portion 54 is not provided at a half of the periphery of the intake port 62a on the cylinder bore center side in the direction of the axis line L1 of the intake valve 24, and is provided at the remaining half of the periphery of the intake port 62a on the cylinder bore outer periphery side in the same direction.

FIG. 19 is a cross-sectional view of a configuration around each intake port 16a, taken along the line K-K in FIG. 18. Because the protruded portions 54 formed as described above are provided, intake air that flows in from each intake port 16a is difficult to flow towards the portion at which the protruded portions 54 are provided because of a narrow clearance as shown in FIG. 19. On the other hand, intake air is easy to flow towards the portion on the cylinder bore center side at which no protruded portion 54 is provided. Such a tendency becomes remarkable when the valve lift of each intake valve 24 is small because the advantageous effect of each protruded portion 54 increases as the valve lift of the corresponding intake valve 24 reduces. Thus, by reducing the valve lift of each intake valve 24, it is possible to increase the strength of the tumble flow. In this way, an internal combustion engine according to the present application may include a variable tumble flow device that is realized utilizing a combination of each protruded portion 54 with the variable intake valve operating device 52 that is able to change the valve lift of each intake valve 24. In addition, the valve lift of the intake valve 24 may be reduced in order to increase the strength of the tumble flow when the spray penetration force is increased due to a change over time.

Further, in the above described first and second embodiments, with the configuration that utilizes the method of changing the in-cylinder injection ratio R to detect an increase in the spray penetration force due to a change over time, when it is determined that the spray penetration force has been increased, the in-cylinder injection ratio R is brought back to the initial value Rb0, and the TCV 25 is then closed. However, the following operation may be performed in order to avoid an increase in a combustion fluctuation as a result of bringing back the in-cylinder injection ratio R once. That is to say, in a case of the configuration according to the first embodiment that controls the TCV opening degree OP so as to be the required TCV opening degree OPr that is determined with reference to a map, a configuration may be adopted such that the TCV opening degree OP is gradually brought back towards the required TCV opening degree OPr while gradually bringing back the in-cylinder injection ratio R towards the initial value Rb0. In addition, in a case of the configuration according to the second embodiment in which the TCV opening degree is gradually decreased while monitoring the plug-periphery air-fuel ratio, an operation to gradually bring back the in-cylinder injection ratio R towards the initial value Rb0 may also be performed when the TCV opening degree OP is gradually decreased. Further, a configuration may be adopted such that the TCV opening degree OP when the plug-periphery air-fuel ratio becomes richest in the course of execution of such operation is obtained as the required TCV opening degree OPr and such that the in-cylinder injection ratio R at this time, which is not always the initial value Rb0, may be used as the in-cylinder injection ratio R at the time of using the required TCV opening degree OPr.

Further, in the above-described first and second embodiments, taking, as a target, fast idle operation that utilizes stratified charge combustion, a configuration is adopted which, when the spray penetration force is increased due to a change over time, closes the TCV 25 to thereby increase the strength of the tumble flow in order to restore the degree of stratification of the plug-periphery air-fuel mixture. However, a time of performing stratified charge combustion operation that is an object for control according to the present application is not limited to a time of fast idle operation, and, for example, may be a time at which lean-burn operation is performed utilizing stratified charge combustion in a predetermined operating range.

Further, the foregoing first and second embodiments have been described taking a forward tumble flow that ascends on the intake side and descends on the exhaust side as an example of a tumble flow that is generated inside the combustion chamber 14. However, a tumble flow to which the present application can be applied is not limited thereto. FIG. 20 is a view that illustrates the manner in which a reverse tumble flow that descends on the intake side and ascends on the exhaust side is generated inside the combustion chamber 14. When the spray penetration force is increased due to a change over time in an internal combustion engine in which a reverse tumble flow is generated inside a cylinder as shown in FIG. 20, the strength of the tumble flow may be increased by, for example, closing a tumble control valve.

Furthermore, the foregoing first and second embodiments have been described taking an example of the internal combustion engine 10 that includes two intake valves 24 per one cylinder. However, an internal combustion engine that is addressed to the present application is not limited to the one that includes two intake valves per one cylinder, and may, for example, be the one that includes one intake valve or three intake valves per one cylinder.

1. An internal combustion engine in which a tumble flow is generated inside a combustion chamber, comprising:
a spark plug arranged at a central part of a wall surface of the combustion chamber on a cylinder head side;
an in-cylinder injection valve configured to inject fuel at a specific timing so that, when stratified charge combustion operation is performed, a fuel spray proceeds towards a vortex center of the tumble flow;
a variable tumble flow device configured to make a strength of a tumble flow variable; and
a control device configured, when a spray penetration force of fuel that is injected by the in-cylinder injection valve is increased due to a change over time of the internal combustion engine, to control the variable tumble flow device so as to increase the strength of the tumble flow during the stratified charge combustion operation.

2. The internal combustion engine according to claim 1,
wherein the control device is configured, when the spray penetration force is increased due to the change over time, to increase the strength of the tumble flow with the variable tumble flow device during the stratified charge combustion operation until an air-fuel ratio index value that has a correlation with a plug-periphery air-fuel ratio that is an air-fuel ratio of an air-fuel mixture at a periphery of the spark plug at an spark timing stops changing to a rich side.

3. The internal combustion engine according to claim 1,
wherein the control device is configured to control the variable tumble flow device so as to increase the strength of the tumble flow during the stratified charge combustion operation as a degree of an increase in the spray penetration force due to the change over time is larger.

4. The internal combustion engine according to claim 1,
wherein the control device is configured, when the spray penetration force is increased due to the change over time and a size of a combustion fluctuation during the stratified charge combustion operation is greater than or equal to a determination value, to increase the strength of the tumble flow with the variable tumble flow device.

5. The internal combustion engine according to claim 1,
wherein the variable tumble flow device includes a tumble control valve that is arranged in an intake passage of the internal combustion engine and configured to control a flow of an intake air that generates a tumble flow, and
wherein the tumble control valve is configured, in a state in which the tumble control valve is operated so as to close the intake passage, to increase a flow rate of intake air in a portion on an outer side of a flow path cross-sectional surface of the intake passage as compared to a portion on a center side thereof in a direction perpendicular to an axis line of an intake valve when viewing the combustion chamber from the cylinder head side in a direction of an axis line of a cylinder.

6. The internal combustion engine according to claim 1,
wherein the control device is configured, when an air-fuel ratio index value that has a correlation with a plug-periphery air-fuel ratio that is an air-fuel ratio of an air-fuel mixture at a periphery of the spark plug at an spark timing changes to a rich side as a result of the spray penetration force of fuel injection that is performed at the specified timing being decreased, to control the variable tumble flow device so as to increase the strength of the tumble flow during the stratified charge combustion operation.
